(19) United States
(12) Patent Application Publication
(10) Pub. No.: US 2006/0197416 A1
(43) Pub. Date: Sep. 7, 2006

(54) Locking control unit for tool box' drawers

(75) Inventor: Meng-Chieh Tsai, Feng Yuan City (TW)

Correspondence Address: TROXELL LAW OFFICE PLLC, Suite 1404, 5205 Leesburg Pike, Falls Church, VA, 22041, US

(73) Assignee: Tung Chieh Industries Co., Ltd.

(21) Appl. No.: 11/068,977

(22) Filed: Mar. 2, 2005

(51) Int. Cl. E05B 65/46

(52) U.S. Cl. 312/217

(57) ABSTRACT

The present invention mainly provides a kind of Locking Control Unit for Tool Box's Drawers, which mainly is applied to common tool box with cascade drawers in its interior, in which a slant press block and a slant push block were designed on the right and left side of the center of backboard of each drawers respectively; additionally, a fixing seat, with some perforations where locking position holes were set for precise movement, was set being perpendicular to center of the inner side of cabinet and aiming at the proper position of the slant press block and slant push block, in which a group of slide bases were designed which can ascend or descend with levers, so that each drawer can be controlled well and opened based on the collaboration between perforations on the fixing seat aiming at the slant press block and slant push block set on the right and left of the center of backboard in parallel and locking position holes on the slide bases, not affect other drawers.

### BACKGROUND OF THE INVENTION

1) Field of the Invention

The present invention provides a kind of Locking Control Unit for Tool Box's Drawers, which mainly is applied to common tool box with cascade drawers in its interior.

2) Description of the Prior Art

Generally, a tool box comprises cabinet and cascade drawers in its interior, and there are two pair of sliding hardware set on the two sides of each drawer, and sliding hardware was designed according to the comparative position where the ones set for each drawer. By way of slippage of the sliding hardware, drawers can be pushed or pulled, and the cascade drawers are controlled by a lock. When the lock is unlocked, each drawer would be open or closed freely. However all drawers should be closed before the lock is locked, and once all drawers are locked, them would not be opened.

Additionally, because some of the abovementioned drawers which are installed with tools or other various metal accessories will be heavier than the empty ones, all drawers can be opened or closed freely at this circumstance. However when we open one of drawers, possibly the upper and lower drawers would be affected and opened simultaneously; contrarily, for the heavy drawers, it would produce reacting force against the cabinet while being closed, and possibly make the light drawers open. Therefore the whole tool box would tilt without taking notice of the changed center of gravity while some drawers in the tool box are pulled out without careless, and it leaves much to be improved.

### SUMMARY OF THE INVENTION

The present invention mainly provides a kind of Locking Control Unit for Tool Box's Drawers, which mainly is applied to common tool box with cascade drawers in its interior, in which a slant press block and a slant push block were designed on the right and left side of the center of backboard of each drawers respectively; additionally, a fixing seat, with some perforations where locking position holes were set for precise movement, was set being perpendicular to center of the inner side of cabinet and aiming at the proper position of the slant press block and slant push block, in which a group of slide bases were designed which can ascend or descend with levers, so that each drawer can be controlled well and opened based on the collaboration between perforations on the fixing seat aiming at the slant press block and slant push block set on the right and left of the center of backboard in parallel and locking position holes on the slide bases, not affect other drawers.

The operation principle of the present invention is as follows: a kind of locking control unit for tool box's drawers, applied to the tool box comprising a cabinet and cascade drawers, in which a lock was set on the cabinet's front upper case, featuring that: this locking control unit mainly comprises a slant press block, a slant push block, a fixing seat, a group of slide bases and lever. The slant press block and slant push block was designed on the proper position, i.e. the right and left side of the centre of the backboard of each drawer respectively; the fixing seat is perpendicular to the centre of the interior of the cabinet, whose interior is hollow, its front end is at the relative position where the slant press block and slant push block were designed at the both sides of the centre of each drawer respectively, and some perforations are available for the slant push block and slant push block through; this group of slide bases looks like a door, which are set respectively in the fixing seat, at the relative position of perforation set at the front end of fixing seat. And there are two locking position holes set for the slant press block and slant push block through. Additionally, the upper and lower end between the two slide bases were respectively connected by a set of levers designed for controlling the ascent and descent of the slide bases, in which a locking jag was designed at the leading end of one of slide bases; and a deflective section was set at the front end of the locking lever as the control end through the lock, and the end of the locking level goes through the locking jag set on the leading end of slide base, and then through the fixing sheet at the upper section of the cabinet, with the movement of the deflective section of its front end, the slide base would move upwards or downwards.

Based on the abovementioned structure, the unit can prevent other drawers from being open while open one drawer, besides it can lock and control all drawers.

Thereinafter, hereby describe further that by means of illustrating embodiments and drawings.

### BRIEF DESCRIPTION OF THE DRAWINGS

FIG. 1 is the three-dimensional disassembled view of the present invention.

FIG. 2 is the three-dimensional view of the present invention.

FIG. 3-A is the cutaway sketch map of the partial present invention (slant press block).

FIG. 3-B is the cutaway sketch map of the partial present invention (slant push block).

FIG. 3-C is the cutaway sketch map of the partial present invention (slant press block).

FIG. 3-D is the cutaway sketch map of the partial present invention (slant push block).

FIG. 4-A is the cutaway sketch map of the partial present invention (slant press block).

FIG. 4-B is the cutaway sketch map of the partial present invention (slant push block).

FIG. 4-C is the cutaway sketch map of the partial present invention (slant press block).

FIG. 4-D is the cutaway sketch map of the partial present invention (slant push block).

FIG. 5-A is the cutaway sketch map of the partial present invention (slant press block).

FIG. 5-B is the cutaway sketch map of the partial present invention (slant push block).

FIG. 5-C is the cutaway sketch map of the partial present invention (slant press block).

FIG. 5-D is the cutaway sketch map of the partial present invention (slant push block).

FIG. 6-A is the cutaway sketch map of the partial present invention (slant press block).

FIG. 6-B is the cutaway sketch map of the partial present invention (slant push block).

FIG. 6-C is the cutaway sketch map of the partial present invention (slant press block).

FIG. 6-D is the cutaway sketch map of the partial present invention (slant push block).

FIG. 7-A is the cutaway sketch map of the partial present invention (slant press block).

FIG. 7-B is the cutaway sketch map of the partial present invention (slant push block).

FIG. 7-C is the cutaway sketch map of the partial present invention (slant press block).

FIG. 7-D is the cutaway sketch map of the partial present invention (slant push block).

FIG. 8-A is the sketch map of the partial present invention (while the slide base whose leading end was set with a locking jag is pulled upwards)

FIG. 8-B is the sketch map of the partial present invention (while the slide base whose leading end was set with a locking jag moves downwards)

### DETAILED DESCRIPTION OF THE PREFERRED EMBODIMENTS

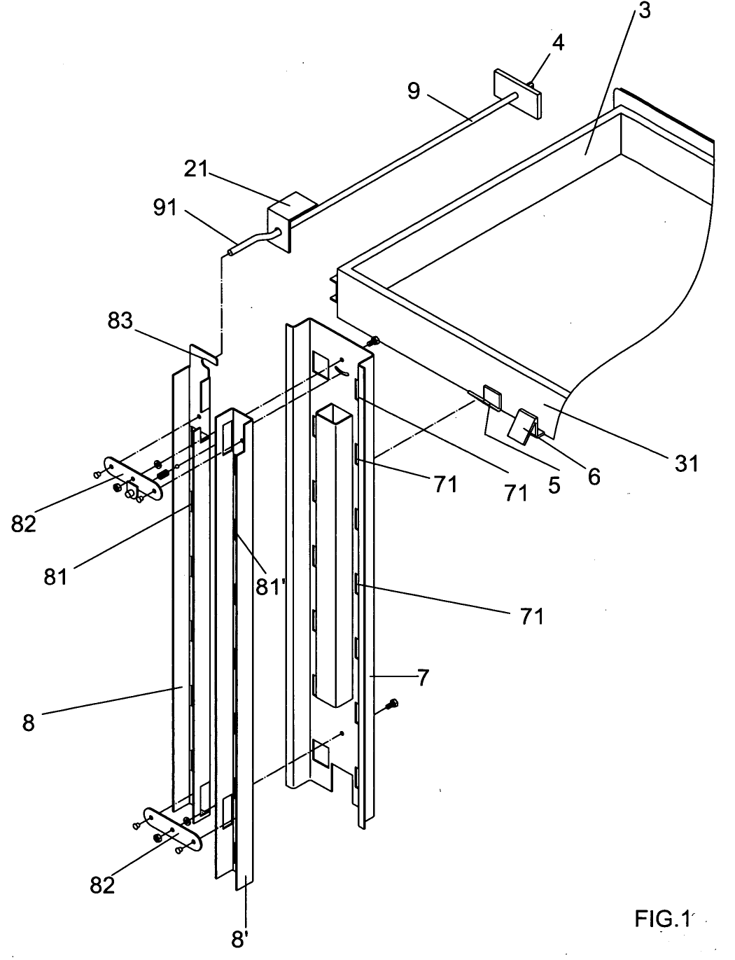

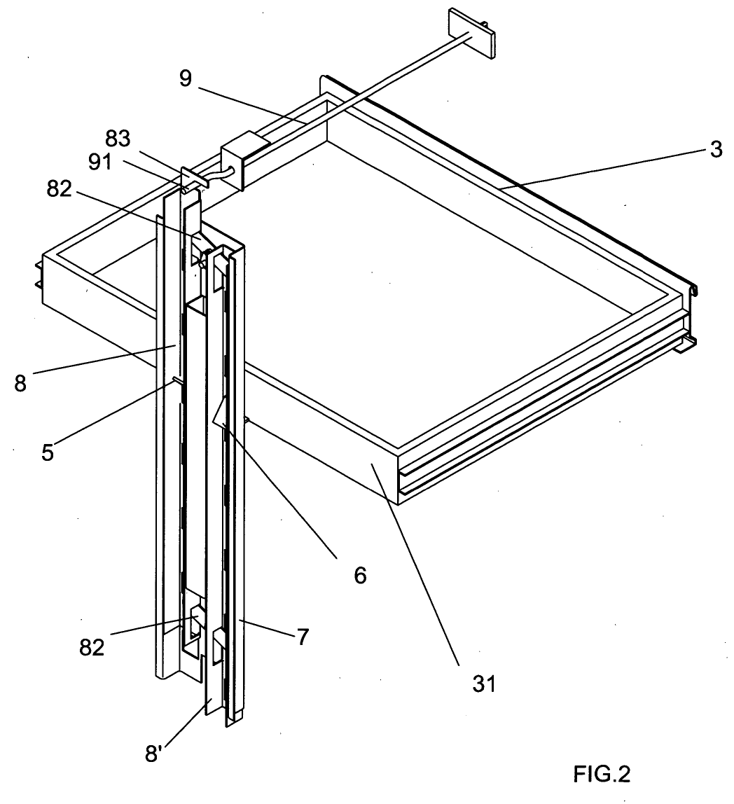

As shown in FIGS. 1 and 2, the tool box the present invention applied to is composed of a cabinet and cascade drawers 3, whose both sides and the inner wall of the cabinet are equipped with sliding hardware (because the practical structure, not available here), and a lock 4 was set on the cabinet's front upper case.

This Locking Control Unit for Tool Box's Drawers mainly comprises:

a slant press block 5 and slant push block 6 was designed on the right and left side of the centre of the backboard of each drawer respectively; and

a fixing seat 7 is perpendicular to the centre of the interior of the cabinet, whose interior is hollow, its front end is at the relative position where the slant press block 5 and slant push block 6 were designed at the both sides of the centre of each drawer 3 respectively, and some perforations 71 are available for the slant push block 5 and slant push block 6 through; and

a group of slide bases 8, 8′ looks like a door, which are set respectively in the fixing seat 7, at the relative position of perforation 71 set at the front end of fixing seat 7. And there are two locking position holes 81, 81′ set for the slant press block 5 and slant push block 6 through. Additionally, the upper and lower end between the two slide bases 8, 8′ were respectively connected by a set of levers 82 designed for controlling the ascent and descent of the slide bases 8, 8′, in which a locking jag 83 was designed at the leading end of one of slide bases 8, 8′; and

a locking lever 9, as the control end through the lock 4, whose front end 91 was set with a deflective section. And after the end of the locking lever 9 goes through the locking jag 83 set on the leading end of slide base, and then through the fixing sheet at the upper section of the cabinet, with the movement of the deflective section of its front end, the slide base would move upwards or downwards.

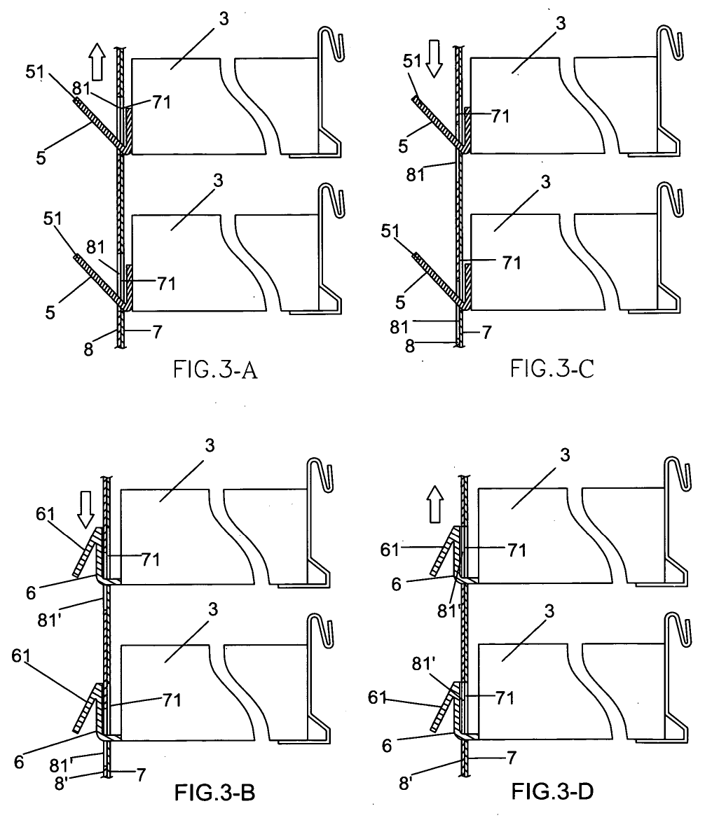

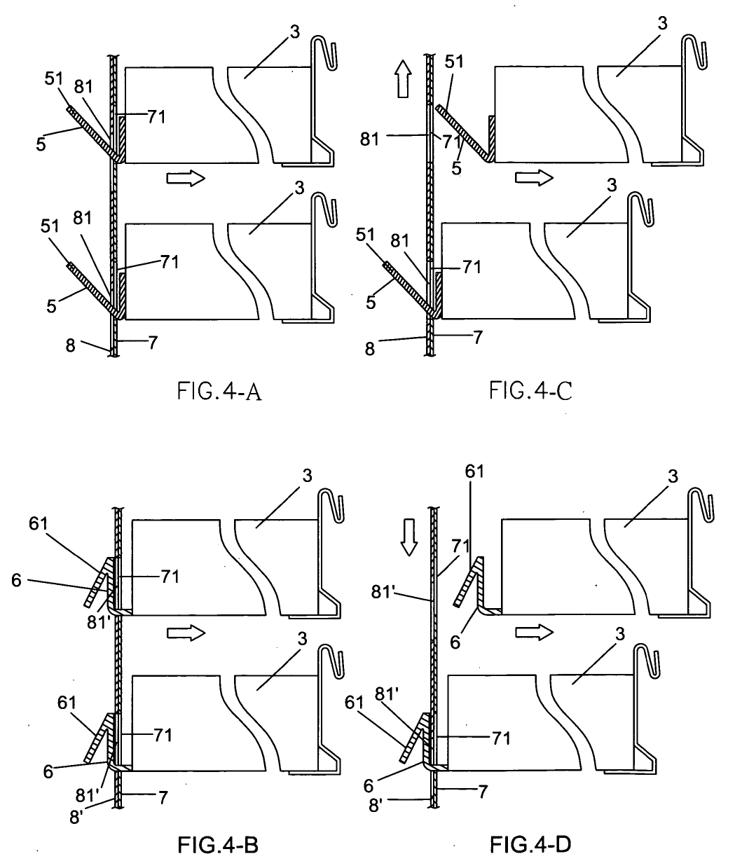

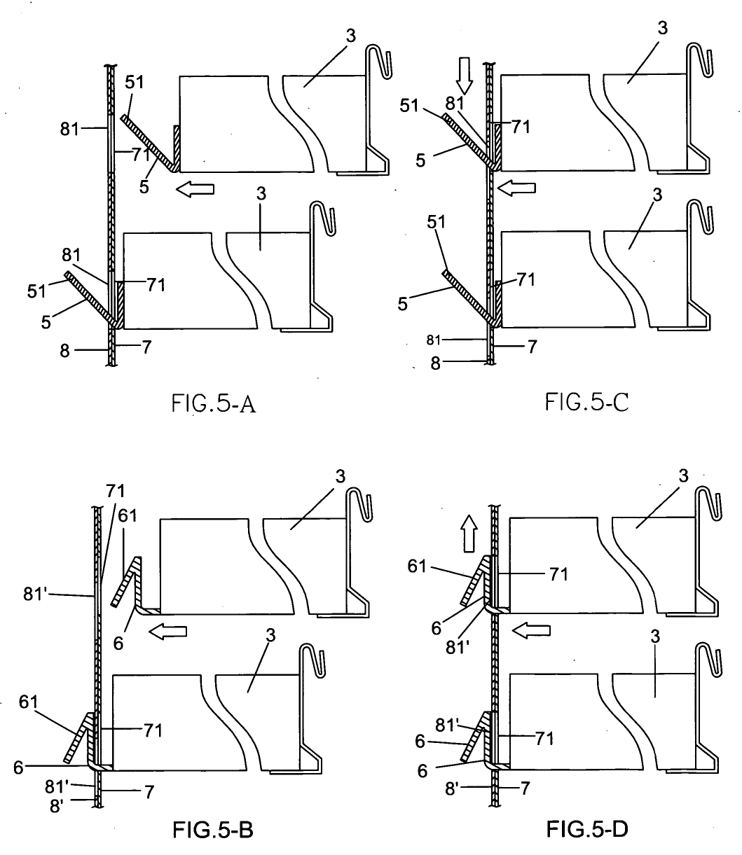

As shown in FIG. 3-A, 3-B and 8-A, based on the abovementioned structure, when user does not use the tool box and wants to close all drawers 3, the user can lock the lock with key to make the front end of locking lever 9 be a deflective section locked in the locking jag 83 set at the leading end of slide base 8, and move the slide base 8 of the group of slide bases 8, 8′ upwards, so that another slide base 8′ will moves downward through the action of a set of levers 82, and the slant push blocks 6 set on the backboard 31 of each drawer 3 are locked for positioning and all drawer 3 would be opened.

As shown in FIG. 3-C, 3-D and 8-B, the operation of unlock the lock 4 to open the drawer 3 with key can make the front end 91 to be a deflective section locked in the locking jag 83 set at the leading end of slide base 8, and move the slide base 8 of the group of slide bases 8, 8′ downwards and hold the top surface of slant press block 5 set on the backboards 31 of cascade drawers 3 for orientation, and the drawer can be opened (according to the connection and turning manner of locking lever 9 and lock 4). Because that is the traditional techniques, the unnecessary details are not available.

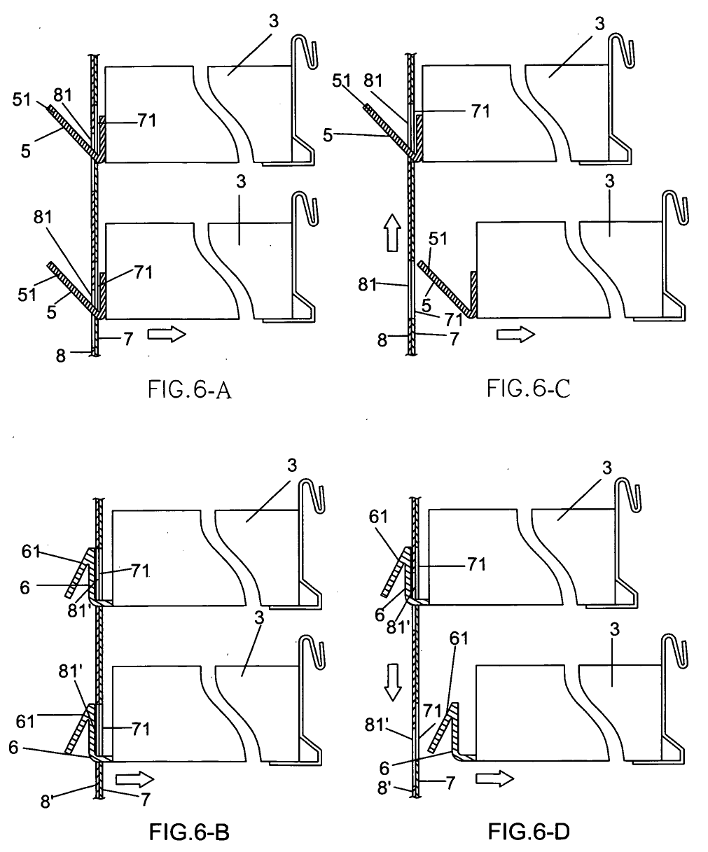

As shown in FIG. 6-A, 6-B, 6-C and 6-D, after unlocking the lock to open one drawer 3 with a hand, based on the beveled design of the top surface 51 of slant press block 5 set on the backboard 31 of the drawer 3, press slide base 8 of the group of slide bases 8, 8′ upwards to move it upwards with the pulling force, and the drawer 3 can be opened. At the same time, other cascade drawers 3 would keep its original state, when the slide base 8 is pressed and moves upwards, the other slide base 8′ will move downwards with the action of a set of levers 82 to position the slant push block 6 set on the backboard 31 of other cascade drawers 3, so that other drawers would not be opened for the pulling force while open each drawer every time.

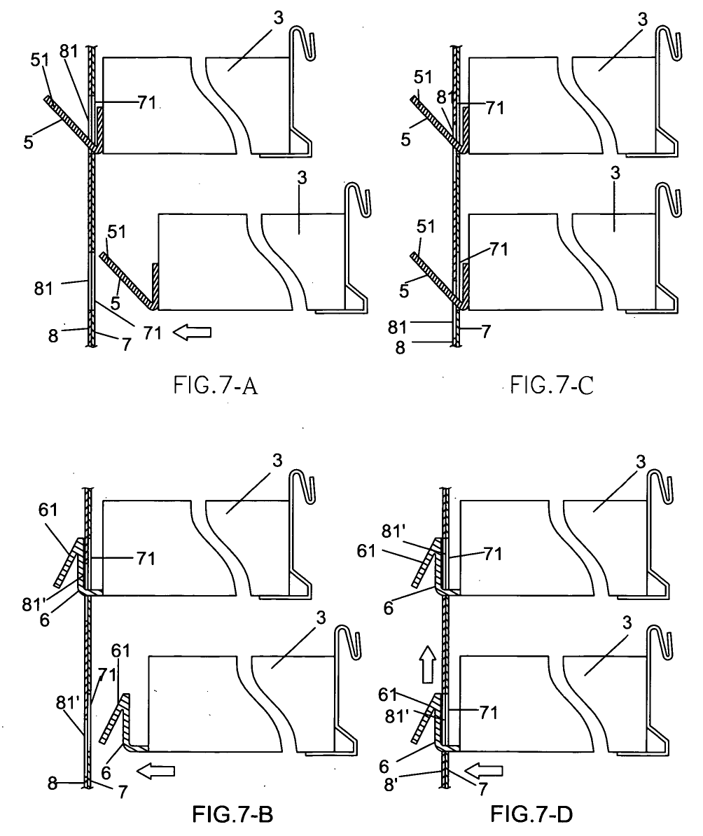

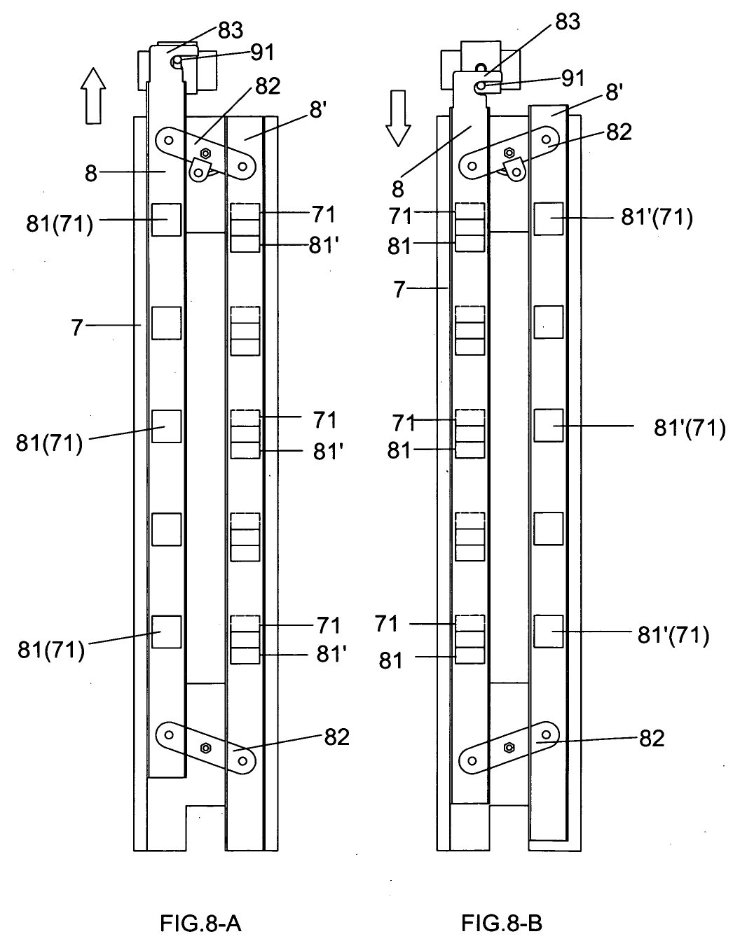

As shown in FIG. 7-A, 7-B, 7-C and 7-D, when close the open drawer 3 again and push the drawers 3 inward, the level surface 61 design that the top surface of the slant push block set on the backboard 31 of drawers 3 has been beveled can be changed, and the slide base 8′ of the group of slide bases 8, 8′can be pushed upwards to move upwards with the force while closing the drawer 3, and the drawer 3 can be closed. At the same time, other cascade drawers 3 would keep its original state, when the slide base 8 is pressed and moves upwards, the other slide base 8 will move downwards with the action of a set of levers 82 to position the slant push block 6 set on the backboard 31 of other cascade drawers 3, so that other drawers would be opened.

Lastly, when all drawers are pushed inwards and closed, the key can be turned, and the lock 4 will drive the locking lever 9 to revolve and the front end 91 forming a deflective section will pull the slide base of the group of slide bases 8, 8′ upwards, and another slide bases 8′ will move downwards under the action of a set of levers 82 to position the slant push block 6 set on the backboard 31 of each cascade drawer 3, which would not be pulled outwards and closed fully. Unless the key would be turned, the drawer 3 cannot be opened.

As abovementioned, the present invention can overcome the defect of the traditional similar products, whose efficiency and advantages are obvious. Additionally it never appears on the current publications, so it is characterized by novelty, creativity and practicality.

What is claimed is:

1. A kind of locking control unit for tool box's drawers, applied to the tool box comprising a cabinet and cascade drawers, in which a lock was set on the cabinet's front upper case, featuring that:
this locking control unit mainly comprises a slant press block, a slant push block, a fixing seat, a group of slide bases and lever. The slant press block and slant push block was designed on the proper position, i.e. the right and left side of the centre of the backboard of each drawer respectively; the fixing seat is perpendicular to the centre of the interior of the cabinet, whose interior is hollow, its front end is at the relative position where the slant press block and slant push block were designed at the both sides of the centre of each drawer respectively, and some perforations are available for the slant push block and slant push block through; this group of slide bases looks like a door, which are set respectively in the fixing seat, at the relative position of perforation set at the front end of fixing seat. And there are two locking position holes set for the slant press block and slant push block through. Additionally, the upper and lower end between the two slide bases were respectively connected by a set of levers designed for controlling the ascent and descent of the slide bases, in which a locking jag was designed at the leading end of one of slide bases; and a deflective section was set at the front end of the locking lever as the control end through the lock, and the end of the locking level goes through the locking jag set on the leading end of slide base, and then through the fixing sheet at the upper section of the cabinet, with the movement of the deflective section of its front end, the slide base would move upwards or downwards.
